(19) United States
(12) Patent Application Publication
(10) Pub. No.: US 2007/0156372 A1
(43) Pub. Date: Jul. 5, 2007

(54) Determining distances in a warehouse

(76) Inventors: Thomas Christ, Kronau (DE); Ralf Schrankler, Hockenheim (DE)

Correspondence Address: SAP/BLAKELY, 12400 WILSHIRE BOULEVARD, SEVENTH FLOOR, LOS ANGELES, CA, 90025-1030, US

(21) Appl. No.: 10/562,378

(22) PCT Filed: Apr. 28, 2004
(86) PCT No.: PCT/EP04/50623

§ 371 Date: Oct. 12, 2006

Related U.S. Application Data
(60) Provisional application No. 60/492,055, filed on Jul. 31, 2003.

(51) Int. Cl. G01B 21/00

(52) U.S. Cl. 702/158; 702/127; 702/155

(57) ABSTRACT

The invention provides methods and apparatus, including computer program products, for warehouse management. In warehouse management it is often necessary to determine the shortest distance a resource has to travel through a warehouse when moving from a location A to a location B. To determine distances the locations are grouped together in zones. For every zone at least one entry and one exit point or node is defined. The function of an entry node and an exit node may be provided by a single node. Every node is defined by its coordinates. The routing is performed in three steps. In the first step a route from a source storage bin to an exit node of the zone is determined. This step may be referred to as “intra zone routing”. The intra zone routing can be done based on a metric. In the second step the distance from the source zone to the destination zone is determined. This step may be called “inter zone routing”. The inter zone routing may be done using a “line-of-sight method”. The third step consists of determining the distance from the entry node of the destination zone to a destination storage bin. This is again an “intra zone routing” as described in the first step.

### RELATED APPLICATIONS

This application claims priority from U.S. Provisional application Ser. No. 60/492,055, filed 31.07.2003, entitled Determining Distances in a Warehouse, the contents of which are incorporated herein by reference.

### FIELD OF THE INVENTION

The invention relates to warehouse management.

### BACKGROUND OF THE INVENTION

In warehouse management it is often necessary to determine the distance a resource has to travel through a warehouse when moving from a location A to a location B. This can be one of the objectives of a task and resource management system (TRM) for warehouse operations. In order to determine the distance the system needs to know the distance for every pair of locations. Locations may be storage bins, high bay racking zones, pallet zones, loading and unloading zones, etc. For increasing numbers of locations, determining distances soon gets very difficult. For example, to determine distances for a warehouse with only 1.000 bins, one would need to type in 1.000.000 distances.

### SUMMARY OF THE INVENTION

In one embodiment, the present invention provides a method of determining a path length in a warehouse between a first location, which is in a source zone of the warehouse, and a second location, which is in a destination zone of the warehouse, each zone having at least one entry node and/or exit node, the method comprising the following steps:
a first step of determining the distance within the source zone between the first location and an exit node of the source zone;
a second step of determining the distance between the exit node of the source zone and an entry node of the destination zone;
a third step of determining the distance within the destination zone between the entry node of the destination zone and the second location;
a fourth step of obtaining the path length by summing up the distances determined in the preceding steps.

Particular embodiments of the invention may comprise one or several of the following features:

The distance within a zone may be determined by applying a metric defined in the zone.

The distance between two zones may be determined by applying a line-of-sight principle.

In a further aspect, the location may be defined by coordinates within the zone.

Further the exit node and the entry node may be defined by coordinates within the respective zone.

The metric applied in a zone may be one of Euclidean metric and Manhattan metric.

The line-of-sight principle may be defined to comprise determining the distance of the direct way between the two zones.

The second step may comprise, in case there is an obstacle blocking the direct way between the two zones, determining an additional distance for a path around the obstacle.

The distances between nodes of two different zones may be looked up in a table which comprises pre-calculated distances of each pair of nodes of different zones.

The present invention further provides a method of determining a path in a warehouse for movement of a resource between a first location, which is in a source zone of the warehouse, and a second location, which is in a destination zone of the warehouse, wherein the path length is determined with the method as defined above.

Hereby, path may be routed based on properties of at least one of a resource, a route, and a node.

Further, the one path may be determined which is the shortest path between the first location and the second location.

Yet further, the present invention provides a method of calculating a path in a warehouse between a first location, which is in a source zone of the warehouse, and a second location, which is in a destination zone of the warehouse, each zone having at least one entry node and/or exit node, the method comprising the following steps:
determining a route from the first location to an exit node of the source zone;
determining the distance within the source zone between the first location and the exit node of the source zone;
determining a route from the exit node of the source zone to a pick and drop point associated with the source zone;
determining the distance between the exit node of the source zone and the pick and drop point associated with the source zone;
determining a route from the pick and drop point associated with the source zone to a pick and drop point associated with the destination zone;
determining the distance between the pick and drop point associated with the source zone and the pick and drop point associated with the destination zone;
determining a route from the pick and drop point associated with the destination zone to an entry node of the destination zone;
determining the distance between the pick and drop point associated with the destination zone and the entry node or the destination zone;
determining a route between the entry node of the destination zone and the second location;
determining the distance within the destination zone between the entry node of the destination zone and the second location;
obtaining the path length by summing up the distances determined in the preceding steps.

Herein for each route, a resource may be determined which is able to move on the route.

Hereby, only such routes may be determined on which selected resources are able to move.

Hereby, the shortest path between the first location and the second location may be determined.

In a further aspect, the one path is determined which satisfies best a cost criterion, the cost criterion taking into account at least one of distances of the routes, travel time for the resource on the routes, and characteristics of the resources.

Herein each route determining step may be followed by a step of calculating a cost criterion, whereby calculating the cost criterion takes into account at least one of distances of the respective determined route, travel time for the resource on the respective determined route, and an average value of characteristics of all the resources for the respective determined route.

The present invention further provides a method of modeling a warehouse with a computer system, the warehouse comprising a plurality of bins for storing goods, a plurality of work centers for processing goods, and a plurality of resources for moving the goods in the warehouse; the method comprising the following steps:
a first step of defining a first plurality of zones, each zone representing a grouping of bins, or a work center, whereby with each zone, at least one node is associated, the node representing an entry and/or exit point for resources to/from the zone, and whereby with each bin and with each node in a zone, coordinates are associated which are representative of their location in the zone;
a second step of defining a first plurality or routes, each route representing a path for movement of a resource between nodes or a pair of zones, whereby with each of the routes, a path length is associated which is representative of the length of the route;
a third step of defining a second plurality of routes, each route representing a path for movement of a resource within a zone between a bin and a node of the zone; whereby with each of the routes, a path length is associated which is representative of the length of the route.

This method may further comprise defining a plurality of resource types, each resource type representing a kind of facility used for movement of a good within the warehouse.

Yet further, this method may comprise defining a plurality of exceptions, each exception representing an obstacle for movement of a resource type on a route, whereby with each obstacle, a path length is associated which is representative of the length of the detour caused for the resource type to move around the obstacle.

Furthermore, the method may comprise defining a plurality of mandatory routes, each mandatory route representing a forced route for movement of a resource type, whereby with each mandatory route, a path length is associated which is representative of the length of the mandatory route.

Further, the method may comprise
a step of defining a further plurality of nodes, each of the nodes representing a predefined location in the warehouse outside the zones;
a step of defining a third plurality of routes, each of the routes representing a path for movement of a resource between a node of the further plurality of nodes and a another node, whereby with each of the routes, a path length is associated which is representative of the length of the route.

The method may comprise associating with each resource type attributes which are descriptive of physical properties of the resource type. Those properties may be one or several of velocity, number of pallets that can be carried, maximum level of height that can be reached.

The method may further comprise associating with each node attributes which are descriptive of physical properties of the node. Those properties may be one or several of logical vs. Physical node, entry/exit node, xyz-coordinates.

The method may further comprise associating with each route attributes which are descriptive of physical properties of the route, e.g., resource types that are allowed for this route.

Herein the second and third pluralities of routes may be stored in a set of tables, each of the routes being referenceable by the two nodes between which the route is defined.

The method may further comprise defining a second plurality of zones, each of the zones representing an entry and/or exit point to/from the warehouse, whereby with each zone, at least one node is associated, the node representing an entry and/or exit point for resources to/from the zone.

The present invention provides also a computer-readable storage medium comprising code for performing the inventive methods, when executed in a computer system.

For the above example with 1.000 bins, the user does not have to enter into the system the 1.000.000 distances between the bins. He just has to group them to zones and to define the entry/exit nodes of these zones. If there are obstacles on the shop floor of the warehouse, he additionally has to define these obstacles. All the rest is done using the defined metrics and the line-of-sight method.

Details of one or more implementations are set forth in the accompanying drawings and the description below. Other features and advantages may be apparent from the description, the drawings, and the claims.

### BRIEF DESCRIPTION OF THE DRAWINGS

FIG. 1 shows a view of an exemplary model warehouse;

FIG. 2A shows the inventive principle of three-step routing;

FIG. 2B shows a block diagram of the routing principle of FIG. 2A;

FIG. 3 shows an exemplary route in the warehouse of FIG. 1;

FIG. 4 shows the floor plan of the exemplary model warehouse of FIG. 1;

FIG. 5 shows the exemplary model warehouse of FIG. 1 mapped to the node/zone concept;

FIG. 6A depicts the different steps of the inventive route determination principle;

FIG. 6B displays a flow diagram of the route determination principle of FIG. 6A;

FIG. 7 shows an exemplary definition of an exception for route calculation;

FIG. 8 shows an example for calculating mandatory routes;

FIG. 9 shows the services provided by the route in a table; and

FIG. 10 shows a diagram of basic interaction between the three processes together with the respective services.

### DETAILED DESCRIPTION OF THE INVENTION

Referring now to the drawings, aspects of the present invention and the exemplary operating environment will be described.

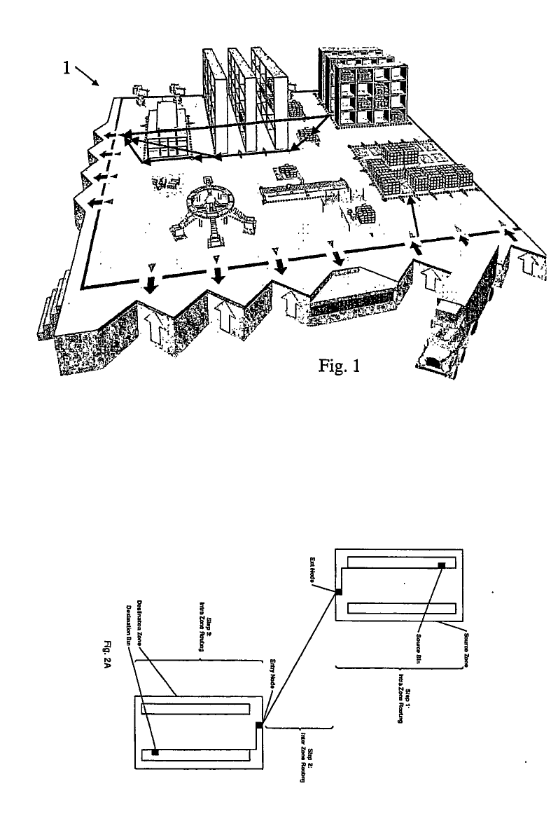

The exemplary model of a warehouse according to FIG. 1 comprises a goods entry zone with 3 doors, a bulk storage area, two high rack storage types, a fixed bin storage type for picking, a conveyor, a sortation loop, some work centers, a couple of pick-and-drop (P&D) locations, and a goods issue zone with 8 doors.

In order to avoid disadvantages like manual input of all the distances, a method is provided that divides the problem of determining distances between two locations in smaller sub-problems and puts the solutions of the sub-problems together to obtain an overall solution.

Locations are grouped together in so-called zones. A zone can be, for example, a group of storage bins. In a high rack storage this can be for example an aisle. Thus, there can be a source storage bin belonging to a zone and a destination storage bin belonging to another zone. Further, for every zone at least one entry and one exit point or node is defined. The function of an entry node and an exit node may be provided by a single node. Every storage bin can be characterized by (preferably x, y, z)-coordinates.

In one embodiment of the invention, which is displayed in FIGS. 2A, B, the actual routing is performed in three steps. In the first step, a route from a source storage bin to an exit node of the zone which the source bin belongs to is determined. This step may be referred to as “intra zone routing”. The intra zone routing can be done based on a metric. The metric may be one of Euclidian metric, Manhattan metric or any other metric that is suitable to describe distances for the respective zone. The distance from the source bin to the exit node is determined using the metric that has been defined for this zone. In different zones different metrics may apply. In the second step, the distance from the source zone to the destination zone is determined. This step may be called “inter zone routing”. The inter zone routing may be done using a “line-of-sight method”. In this method, the basic assumption to simplify the determination of distances is that there is a line-of-sight between an exit node of the source zone and an entry node of the destination zone. For exceptions so-called “obstacles” can be defined. If there is no line-of-sight because there is an obstacle, this obstacle can be defined in the system and the mechanism then determines the distance, taking into account that the resource has to travel around the obstacle. Obstacles may be defined with two edges (e.g. wall) or four edges (e.g. rectangle). The third step comprises determining the distance from the entry node of the destination zone to a destination storage bin. This is again an “intra zone routing” as described in the first step.

In an additional fourth step, the distances determined in the preceding three steps are summed up in order to obtain the length of the path from the source storage bin in the source zone to the destination storage bin in the destination zone.

In case the destination zone is an exit of the warehouse, for example a loading and unloading zone, the third step has not to be performed or results in a zero distance. In the same way, it may happen that the source destination is an entry point into the warehouse. Accordingly, in that case, the first step has not to be performed or results in a zero distance.

One basic assumption of the approach according to the invention is that “what is not forbidden is allowed”. So if a resource should move from a location A to a location B, the distance between the coordinates of the two locations is calculated by using the predefined metric. Only if there is a problem, for example there is an obstacle in between, the routing algorithm has to be more refined.

Thus, first the system tries to determine a route according to the predefined metric. If there is an obstacle in between, the system recognizes this and calculates a route via the edges of the obstacle (line of sight).

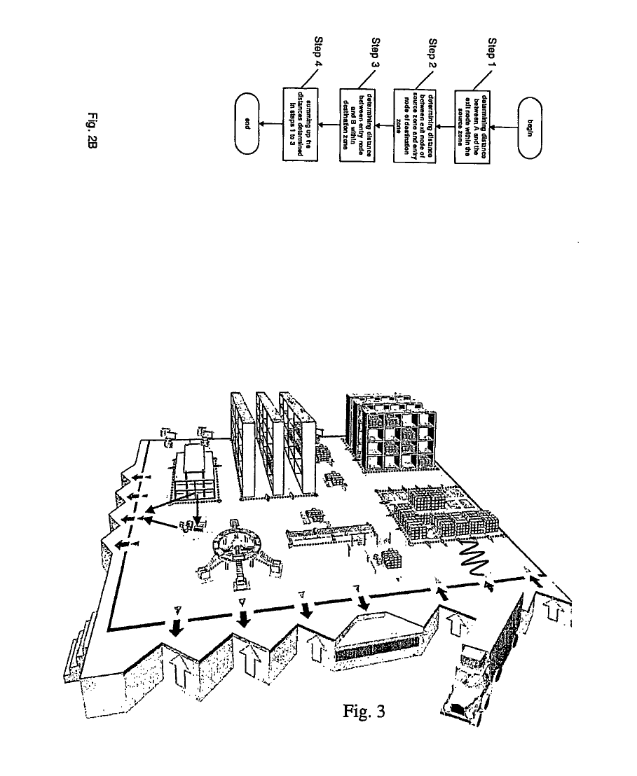

FIG. 3 shows one example of a route in the warehouse of FIG. 1.

Another reason for not just taking the direct route (using the metric) may be a forced P&D. This means that for some reason or another there has to be done for example a packing operation. The system then first calculates the route to the appropriate packing station and from there to the final destination.

In the case where the movement has to be done in a rather strange shape, there is the possibility to enter the distance between two points in an exception table.

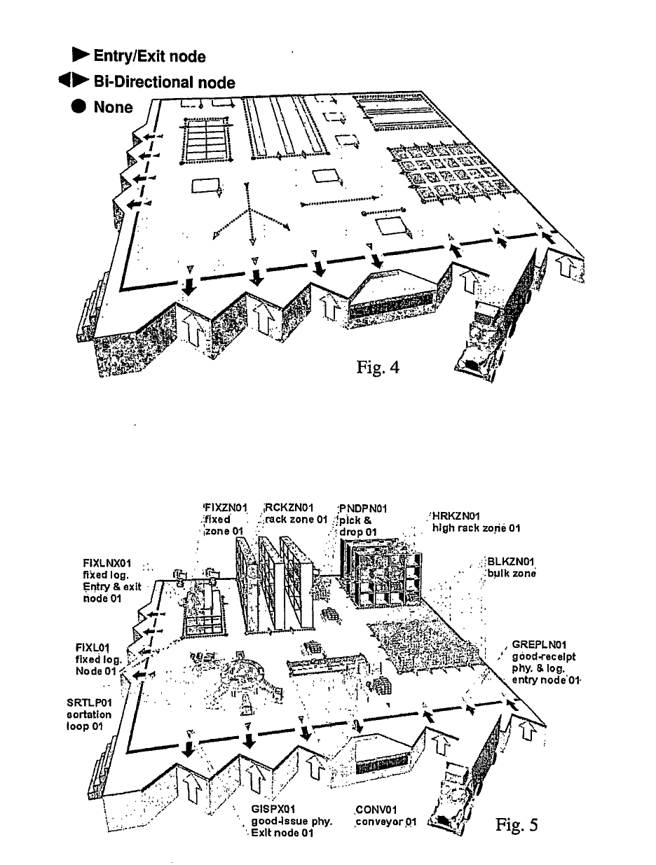

FIG. 4 shows the floor plan of the exemplary model warehouse of FIG. 1. First a metric is defined for the whole warehouse or for special zones within the warehouse. In an aisle for example the Manhattan metric is applied whereas in the rest of the warehouse the Euclidean metric is applied.

To describe the rest of the objects apart from the WM storage bins, also nodes are used. Nodes may be either logical or physical or both.

A logical node is only used for the routing algorithm. It is just a logical construction. On a logical node nothing can be stored or put down. Examples for logical nodes are the entry and exit points of aisles or the edges of an obstacle.

A physical node serves for the routing as well as for storing goods. Examples are P&D locations.

Among the nodes, it is distinguished between entry and exit or bi-directional nodes or nodes that are neither entry nor exit nodes (obstacles).

Objects like walls or storage types are defined as obstacles for the routing algorithms.

FIG. 5 shows the exemplary model warehouse of FIG. 1 mapped to the node/zone concept. For example there are the following items given:

A physical entry node, representing one of the doors of the goods receipt area;

A physical exit node, representing one of the doors of the goods issue area;

A logical node representing an edge of the fixed bin storage type as an obstacle;

An entry and exit node for the fixed bin area;

Some other warehouse zones, like the bulk zone or some zones within the high rack; and

the P&Ds and the conveyor or sortation loop.

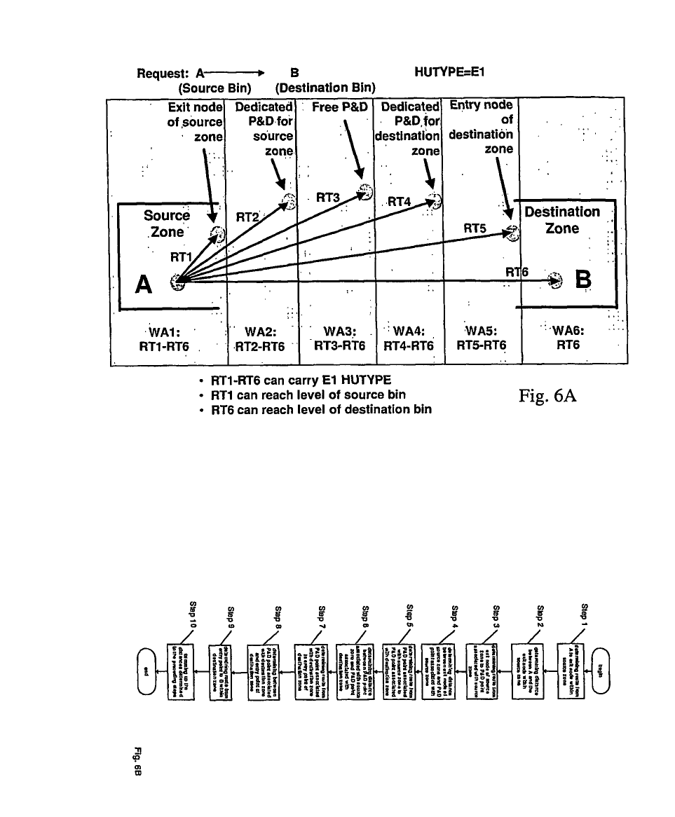

FIGS. 6A, B depict the different steps in the route determination from source A to destination B. First, the exit node of the source zone is determined, then, it is checked if there is a dedicated P&D for the source zone. Then, it is checked whether one of the free P&Ds should be taken into account. Free P&Ds are such P&Ds that are not dedicated to a specific zone. Then, the same checks are made for the destination bin, it is looked for dedicated P&Ds for the destination zone, for the entry node of the destination zone, and at last for the destination bin. The restrictions in this example are that the whole route must be able to carry El pallets, that the start of the route must be done by a resource that can reach the source level and that the end of the route must be done by a resource that can reach the destination level.

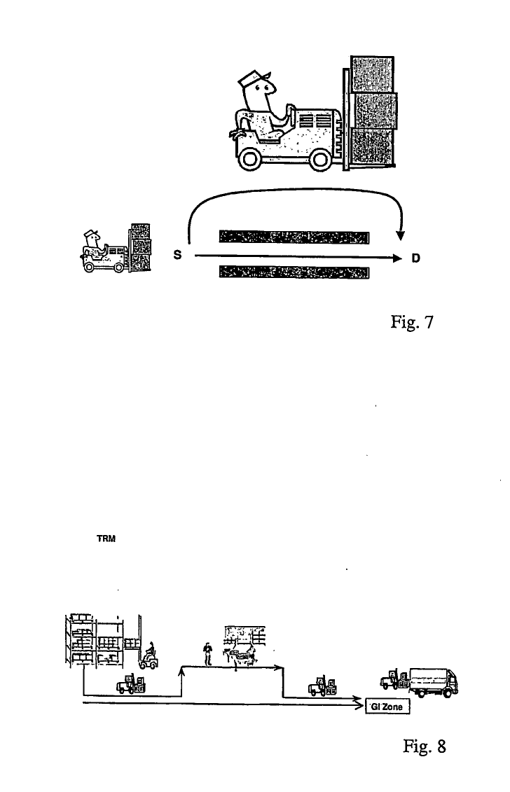

FIG. 7 shows an exemplary definition of an exception for route calculation. Whereas the narrow aisle forklift can pass through the narrow aisle, the standard forklift has to make a detour. The distance will not be 10 meters but 15 meters instead. The exceptions can be defined per route (source node/destination node) and resource type. Routes can also be completely disabled.

FIG. 8 shows an example for calculating mandatory routes. Mandatory routes can be treated as exceptions. They force a route to be constructed via a specific node (e.g. P&D, Work Center). For example all the pallets that are sent from the high-rack storage to the goods issue area have to be shrink-wrapped. So they will be sent via the shrink wrap machine to the goods issue area.

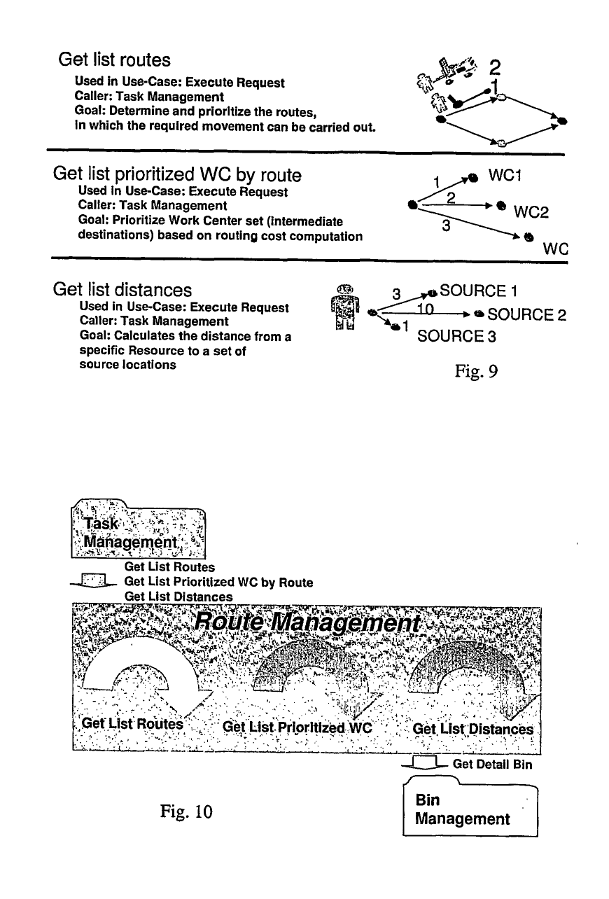

FIG. 9 shows the services of the Route Management for the other packages. There are:

Get list routes: This gives a list of all the possible routes to the caller.

Get list prioritized WC by route: this gives a prioritized list of all the possible work centers to the caller.

Get list distance: This gives the distance of a specific resource to different source locations (e.g. useful for task interleaving).

FIG. 10 depicts all the three processes together with the services according to the process model.

To summarize:

Route Management has the control over the areas:
Zone to zone (inter zone) parameters and metric;
Overall (inter+intra) zone routing calculations, based on defined metric and taking into consideration any defined exception;
Nodes with their attributes;
Dedication of nodes to zones;
Enforcement of mandatory routes (i.e. passing via zone); and
Compute weighted cost of Resource Type's movement, given the calculated duration and execution qualifications preferences.
Computing the weighted cost of the movement means, that it does not only take into account the calculated distance between two points but also the duration (via the velocity of the resource) together with the execution preferences, i.e. some routes may be more appropriate to a specific resource than others (ex. In a narrow aisle, only the narrow aisle forklifts are allowed to move). The resource management manages all the master data related to workers, devices and resources in the warehouse. Additionally, it has the visibility over dynamic resource information (e.g. statuses). This information enables keeping track of all resources currently present/active in the system, thus enables control of resources.

The package has the roles of resources administration, and manage all the information associated with Resources.

The package has control over the areas of Qualifications, resource characteristics (e.g. velocity (x, z)), and audit trail (i.e. resource ‘BOM’ history and statuses).

The Site Map Management package has a comprehensive visibility of the warehouse. As such, it manages the following site map information:
Bins (e.g. storage bin, work center (WC), pick-up & drop-off points (P&Ds));
Logical and physical bin groupings (e.g. zones);
Bin content & capacity;
Routes with associated information (e.g. duration, priority etc.);

The package is comprised of two subsystems, namely Bin Management, and Route Management.

Bin Management manages information associated with physical floor entities and their logical groupings.

The subsystem roles are: it manipulates bins to zones/coordinates for navigation purposes, and it prioritizes Work Centers based on the required operation.

Bin management has a control over the areas of bins and coordinates, zones, capacity & content, and Work Centers' roles.

The route management manages route information and provides cost/priority calculations.

The routes and their cost calculations, which are based on route, bin and resource type aspects aim to support decision-making concerning Task creation and selection.

The Route Management manages the route information (e.g. P&D dedications, metrics, nodes' attributes). It manipulates bin, resource capabilities and preferences to routing terms and it provides cost or priority calculations based on the defined metric.

Route Management has the control over the areas of distances between nodes, zone groups, and calculation metric.

Resource Element Type stands for role definition in the warehouse. It is used to define the required roles for Resource Type's construction, which are eventually compared with the allowed Resource Element Types of the Resource Element whenever the construction takes place. The Resource Element Type (the role) is determined for each Resource Element, as soon as it was logged on successfully to the system.

The main characteristic of the resource is its Resource Type. The Resource Type has its own identification and description (e.g. “forklift”) and a set of other properties.

Resource Element represents the workers and the devices in the warehouse. These are Elementary components, of which a Resource is composed. The differentiation between workers and devices is made to determine the required information and the system (i.e. HR/PM) TRM should access to get the information from. The same differentiation is required for similar reasons for TRM inbound interactions from external systems.

Qualifications determine the capabilities of the Resource Elements and Resource Types. There are two types of qualifications, which are selected to be used depending on the time related to the logon milestone, namely Logon Qualifications, and Execution Qualifications.

The Logon Qualifications determine the skills (or roles) for Resource Elements, which are being checked against in the logon process. They are used up to the point when the Resource Element was successfully logged on to the system.

Execution Qualifications are used from the point the Resource has logged on to the system, until its logoff. They define the capability and preferences of performing a certain Task based on its properties (e.g. Working Area, levels, Handling Unit Type). The Execution Qualifications deal with execution perspective and as such, they remain always active (they are not logon dependent) for Resource Type, throughout its life.

Resource construction is based on the determined resource type. Once the Resource construction has been accomplished by logging on all the required resource elements that satisfy all the resource element types, an identification number is assigned to it. It should be noted that in the future, the option that enables logging on to a specific Resource would be considered.

As soon as the Resource is created, it inherits all Resource Element attributes along with the Resource Type's attributes and all its actions and statuses are being tracked from now on.

Resource profile is comprised of user preferences, device capabilities, Worklist size, Task release strategy, ability to execute clustered and interleaving Tasks and notification agent parameters.

The Route and Bin subsystems' data model are represented together since they are both strongly related to each other, and the Bin Management has (almost) no proprietary entities.

Node: The various warehouse nodes' information In addition to the geographical location of the nodes, this entity defines their type and behavior.

Zone: This entity concentrates the Zone related information. One of its most important Tasks is to save the intra zone properties, such as the metric used for distance calculation.

LAGP: This LES' table maps bins onto their Zones to achieve another grouping for routing purposes. In addition, this table is to contain geographical location of the bins as well as sequencing information.

Zone—Node dedication: Each node may serve one zone (or more) as an entry/exit point and one zone may be served by several nodes. This entity contains this cross-referencing information.

Obstacle: This table maps physical obstacles within the warehouse onto nodes. Each obstacle serves as input for the connectivity graph (i.e. nodes connected by line of sight).

Neighbor Nodes Distance: By combining the node and obstacle tables together, the neighbor table could be derived. This oriented graph represents pairs of connected nodes. Any pair of nodes is checked against the obstacle table to ensure the existence of Line of Sight.

Inter-Route exception: Using the metric defined across TRM, the distance between pairs of points can be calculated. This entity (positively) defines exceptions to the above rule. This table is Resource Type related, namely, the exception in the distance calculated between a pair of nodes could be attached to a specific Resource Type.

Routing Table: This entity represents the ‘shortest path’ between any two nodes in the warehouse. The Neighbor Nodes Distance table, together with the Inter-Route Exception table, is used as the input for the Routing table. The above pre-calculation is skipped for logical pairs that contain logical nodes that are not served as either entry or exit points.

Mandatory Routes: This entity enables degeneration of the routing model for special purposes by overruling the Routing table information. Mandatory Route may be defined (as a configuration) between any pair of zones.

The following services are given:

Get List Routes
Import HU information, move information and Resource Type list (optional);
Export: Next destination set, prioritized Resource Types per each destination.

Get List Prioritized WC by Route
Import: Move information, Work Center list, and HU information (optional);
Export: Prioritized Work center list.

Get List Distances
Import: Source location, Destination list and Resource information;
Export: Prioritized (by distance) destination list.

Modules

The whole warehouse complex may be represented as zones connected by routes. The zones are similar to (and in many cases the same as) LES' storage types. However, it is preferable not to use an external subdivision for internal purposes, since there is no guarantee that it will always fit into our needs. Aisles are strongly related to Resources abilities, and thus will be mapped onto zones. That is to say, all the bins belong to an aisle will be pointing to the same zone identifier.

Nodes are abstract entities used to enable easy configuration and calculation of routes. The nodes may represent both physical entities (e.g. P&D locations) and logical ones (such as zones' entry/exit points).

Any movement is then defined between pairs of source bin/node and destination bin/node.

Get List Routes

As mentioned, Task Management invokes this service in full scale on Task creation phase. In return, Route Management sends back a list of optional tasks' routings. Nonetheless, the choice of the particular routing option will be left to the caller.

Task Routing refers to the ‘next step’ suggested rather than the whole (source to destination) path. Namely, the Route management suggests all the sub paths that eventually lead to the required destination. However, the path as a whole is a special case in its sub-path set.

This chief module serves all the above listed Transactions. In the most general case, it receives source, destination, and HU type to be moved. As output, the module will provide possible routes with a list of corresponding Resource Types. Each pair (Route-Resource Type) has its own priority, which expresses the overall (estimated) cost of the route along with the Resource Type preferences to execute the suggested task routing.

To allow use of an external routing engine, the Route Management is preferably configurable separately from all the rest or the TRM system. It may “know” most of the entities used in the TRM system (Resource Type, Bin etc), but the TRM must not know any of the routing internal entities.

Function Modules

Routing Algorithm:

The Routing algorithm uses the Roadmap approach, which is based on 2 layers: intra-zone (city map) and inter-zone (highway paths). While intra-zone refers to movements inside aisles, the inter-zone navigation represents movements between aisles.

Any movement within the warehouse can be considered as a superposition of intra and inter zone movements. Therefore, it can be calculated using the abovementioned algorithms. The entry/exit nodes of zones define the tangent boundaries between the two routing algorithms.

Since only the next step must be returned, the procedure must first consider all movement possibilities from source. Thereafter, for each ‘next step’ calculated, the Rest of Trip cost (ROT—movement from the current ‘next step’ to destination) has to be estimated. The overall cost (to ‘next step’ together with the ROT) serves as a common denominator to evaluate the different Routings suggested.

It is to be noted that there is a difference between “next step” calculation and ROT estimation. The first refers to a specific Resource Type; the latter is somehow independent of Resource Type, since it will be determined in the future. The ROT estimation is based on an abstract Resource Type, which can represent an average cost of all the available Resource Types.

Intra Zone Routing:

Intra Zone routing is defined as one of the following movements:
From a bin to the zone exit nodes;
From a zone entry node to the zone's bins;
Moves within a zone.

The model uses the information placed within LES' LAGP and the zone information (local metric) to calculate the cost of these internal moves. The intra-zone calculations are done on the fly, to avoid pre-calculated intra-routes avalanche.

Inter Zone Routing:

Movements between zones are handled using the inter-zone algorithm. To avoid excess of paths, logical nodes were used. Unlike physical nodes, the logical ones serve as junctions and thus do not necessarily represent places where HUs may be placed.

The relationship between adjacent nodes (neighbors) is described using a directed graph. This data model may easily serve as a basis for optimized path calculation between any pair of nodes. Nonetheless, this procedure is both time-consuming (and generally time-boundless). To allow fast lookup, all the possible movements (from physical nodes to physical nodes) are pre-calculated per each resource type.

Get List Prioritized WC:

This special case of the general Routing mechanism aims to solve the cases where no concrete intermediate destination was predefined. Aside of source and destination, this Function Module receives a set of possible locations through which (one of them) the Route may pass. Good example is a requirement to move HU from source to destination via a value-added station (e.g. shrink wrap machine). This procedure usually serves as preliminary stage to the routing phase, for it determines the (best) intermediate location to serve as temporary destination.

Invoking the rough cost estimation of moving from source to destination via the various intermediate locations, enable the latter's prioritization.

Get List Distances:

This is a degenerated case of the routing algorithm, which uses only the distance calculation between pairs of nodes/bins. It is used to better prioritize tasks for a specific Resource according to the latter distance from the tasks' sources.

Services:

Administer Request
Import: Request;
Export: Confirm administration.

Update Request Life Cycle
Import: Task execution data;
Export: Confirm update.

Get Detail Execution Data
Import: Tasks;
Export: Execution data

Modules

Request Administrator:

Request Administrator validates the Request information and manages references to requests along with their normalized priorities. It is responsible for the Request life cycle and for providing confirmations to LES based on the required confirmation method.

Function Modules

Scheduler

The Scheduler is the ultimate Request release controller. It checks the requests is continuously, upon Task confirmation or submission of a new Request. The Scheduler provides the following release related answers based on priorities, grouping and dependencies: When, What and How (release in groups. e.g. merging aspects).

The answer to “When” and “What” deals with scheduling issues that aim to increase the efficiency in the warehouse. The scheduling mechanism releases requests for execution as late as possible, using Request weighted priorities and comparing them to Task priorities (within the Task pool). The release control reduces the number of Tasks within the system and limits the pool just for high priority Tasks. Moreover, by postponing release of requests for execution until the last moment (close to execution), better decisions can be made regarding Task creation.

The answer to “How” deals with merging issue. There is a m:n relation between Request and Task. Several Request Items may be translated into one Task and one Request may be translated into many Tasks. The Scheduler wraps the Request Item(s) to assure the appropriate Task creation. At the first stages of each picking, every Request Item is treated as a separate Task. Thereafter, when the picked materials are to be moved together, the Scheduler will merge them together to assure creation of only one Task.

The optimization roles are satisfied by an internal standard optimization algorithm, but might as well be satisfied by utilizing the provided capability to integrate external scheduling engines.

The present techniques can be implemented in digital electronic circuitry, or in computer hardware, firmware, software, or in combinations of them. The invention can be implemented in a computer program product tangibly embodied in a machine-readable storage device for execution by a programmable processor. Method steps according to the invention can be performed by a programmable processor executing a program of instructions to perform functions of the invention by operating on the basis of input data, and by generating output data. The invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories, in particular from read-only memories and/or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in ASICs (application-specific integrated circuits).

The computer systems or distributed computer networks as mentioned above may be used, for example, for producing goods, delivering parts for assembling products, controlling technical or economical processes, or implementing telecommunication activities.

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus 21. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g. an RF communication link). A display is coupled to an interface, which is coupled to an I/O bus. A keyboard and pointing device are also coupled to the I/O bus. Alternatively, separate buses may be used for the keyboard pointing device and I/O interface.

Other embodiments are in the scope of the following claims.

1. Method of determining a path length in a warehouse between a first location, which is in a source zone of the warehouse, and a second location, which is in a destination zone of the warehouse, each zone having at least one entry node and/or exit node, the method comprising the following steps:
a first step of determining the distance within the source zone between the first location and an exit node of the source zone;
a second step of determining the distance between the exit node of the source zone and an entry node of the destination zone;
a third step of determining the distance within the destination zone between the entry node of the destination zone and the second location;
a fourth step of obtaining the path length by summing up the distances determined in the preceding steps.

2. The method of claim 1, wherein the distance within a zone is determined by applying a metric defined in the zone.

3. The method of claim 1, wherein the distance between two zones is determined by applying a line-of-sight principle.

4. The method of claim 1, wherein the location is defined by coordinates within the zone.

5. The method of claim 1, wherein the exit node and the entry node are defined by coordinates within the respective zone.

6. The method of claim 2, wherein the metric applied in a zone is one of Euclidean metric and Manhattan metric.

7. The method of claim 3, wherein the line-of-sight principle comprises determining the distance of the direct way between the two zones.

8. The method of claim 7, wherein the second step comprises, in case there is an obstacle blocking the direct way between the two zones, determining an additional distance for a path around the obstacle.

9. The method of claim 1, wherein the distances between nodes of two different zones are looked up in a table which comprises pre-calculated distances of each pair of nodes of different zones.

10. A method of determining a path in a warehouse for movement of a resource between a first location, which is in a source zone of the warehouse, and a second location, which is in a destination zone of the warehouse, wherein the path length is determined with the method of claim 1.

11. The method of claim 10, wherein the path is routed based on properties of at least one of a resource, a route, and a node.

12. The method of claim 11, wherein the one path is determined which is the shortest path between the first location and the second location.

13. Method of calculating a path in a warehouse between a first location, which is in a source zone of the warehouse, and a second location, which is in a destination zone of the warehouse, each zone having at least one entry node and/or exit node, the method comprising the following steps:
determining a route from the first location to an exit node of the source zone;
determining the distance within the source zone between the first location and the exit node of the source zone;
determining a route from the exit node of the source zone to a pick and drop point associated with the source zone;
determining the distance between the exit node of the source zone and the pick and drop point associated with the source zone;
determining a route from the pick and drop point associated with the source zone to a pick and drop point associated with the destination zone;
determining the distance between the pick and drop point associated with the source zone and the pick and drop point associated with the destination zone;
determining a route from the pick and drop point associated with the destination zone to an entry node of the destination zone;
determining the distance between the pick and drop point associated with the destination zone and the entry node of the destination zone;
determining a route between the entry node of the destination zone and the second location;
determining the distance within the destination zone between the entry node of the destination zone and the second location;
obtaining the path length by summing up the distances determined in the preceding steps.

14. The method of claim 13, wherein for each route, a resource is determined which is able to move on the route.

15. The method of claim 13, wherein only such routes are determined on which selected resources are able to move.

16. The method of claim 13, wherein the shortest path between the first location and the second location is determined.

17. The method of claim 13, wherein the one path is determined which satisfies best a cost criterion, the cost criterion taking into account at least one of distances of the routes, travel time for the resource on the routes, and characteristics of the resources.

18. The method of claim 13, wherein each route determining step is followed by a step of calculating a cost criterion, whereby calculating the cost criterion takes into account at least one of distances of the respective determined route, travel time for the resource on the respective determined route, and an average value of characteristics of all the resources for the respective determined route.

19. A method of modeling a warehouse with a computer system, the warehouse comprising a plurality of bins for storing goods, a plurality of work centers for processing goods, and a plurality of resources for moving the goods in the warehouse; the method comprising the following steps:
a first step of defining a first plurality of zones, each zone representing a grouping of bins, or a work center, whereby with each zone, at least one node is associated, the node representing an entry and/or exit point for resources to/from the zone, and whereby with each bin and with each node in a zone, coordinates are associated which are representative of their location in the zone;
a second step of defining a first plurality or routes, each route representing a path for movement of a resource between nodes of a pair of zones, whereby with each of the routes, a path length is associated which is representative of the length of the route;
a third step of defining a second plurality of routes, each route representing a path for movement of a resource within a zone between a bin and a node of the zone; whereby with each of the routes, a path length is associated which is representative of the length of the route.

20. The method of claim 19, further comprising defining a plurality of resource types, each resource type representing a kind of facility used for movement of a good within the warehouse.

21. The method of claim 20, further comprising defining a plurality of exceptions, each exception representing an obstacle for movement of a resource type on a route, whereby with each obstacle, a path length is associated which is representative of the length of the detour caused for the resource type to move around the obstacle.

22. The method of claim 21, further comprising defining a plurality of mandatory routes, each mandatory route representing a forced route for movement of a resource type, whereby with each mandatory route, a path length is associated which is representative of the length or the mandatory route.

23. The method of claim 22, further comprising
a step of defining a further plurality of nodes, each of the nodes representing a predefined location in the warehouse outside the zones;
a step or defining a third plurality or routes, each of the routes representing a path for movement of a resource between a node of the further plurality of nodes and a another node, whereby with each of the routes, a path length is associated which is representative of the length of the route.

24. The method of claim 23, further comprising associating with each resource type attributes which are descriptive of physical properties of the resource type.

25. The method of claim 24, further comprising associating with each node attributes which are descriptive of physical properties of the node.

26. The method of claim 25, further comprising associating with each route attributes which are descriptive of physical properties of the route.

27. The method of claim 26, wherein the second and third pluralities of routes are stored in a set of tables, each of the routes being referenceable by the two nodes between which the route is defined.

28. The method of claim 27, further comprising defining a second plurality of zones, each or the zones representing an entry and/or exit point to/from the warehouse, whereby with each zone, at least one node is associated, the node representing an entry and/or exit point for resources to/from the zone.

29. A computer-readable storage medium comprising code for performing the method of claim 1, when executed in a computer system.

30. A computer-readable storage medium comprising code for performing the method of claim 13, when executed in a computer system.

31. A computer-readable storage medium comprising code for performing the method of claim 19, when executed in a computer system.
